(19) United States
(12) Patent Application Publication
(10) Pub. No.: US 2025/0061603 A1
(43) Pub. Date: Feb. 20, 2025

(54) FIXING-STATE DETERMINATION SYSTEM AND GLOVE

(71) Applicant: MITSUBISHI ELECTRIC CORPORATION, Tokyo (JP)

(72) Inventors: Kotaro FUKUI, Tokyo (JP); Keishi NISHIKAWA, Tokyo (JP)

(73) Assignee: MITSUBISHI ELECTRIC CORPORATION, Tokyo (JP)

(21) Appl. No.: 18/931,581

(22) Filed: Oct. 30, 2024

Related U.S. Application Data
(63) Continuation of application No. PCT/JP2022/020458, filed on May 17, 2022.

(51) Int. Cl. G06T 7/73; A41D 19/00; G06T 7/20; H04N 23/57

(52) U.S. Cl. CPC G06T 7/73; A41D 19/0024; G06T 7/20; H04N 23/57; G06T 2207/30196; G06T 2207/30204

(57) ABSTRACT

A fixing-state determination system includes a glove an operator wears. A photographing device is placed at a position of the glove that corresponds to a portion between a pair of fingers which grip a target object, and photographs a target image. A position-and-posture estimation unit estimates a position and posture of the target object. A range calculation unit calculates a fingertip movement range which is a movement range of a fingertip of the operator. A contact position calculation unit calculates a contact position of the fingertip on the target object on a basis of the position and posture of the target object and the fingertip movement range. A determination unit determines a fixing state of the target object on a basis of displacement of the target object and excitation force information of an excitation force at the contact position of the fingertip for the target object.

### CROSS REFERENCE TO RELATED APPLICATION

This application is a Continuation of PCT International Application No. PCT/JP2022/020458, filed on May 17, 2022, which is hereby expressly incorporated by reference into the present application.

### TECHNICAL FIELD

The present disclosure relates to a fixing-state determination system, a glove, an information processing device, a fixing-state determination method, and a fixing-state determination program.

### BACKGROUND ART

A glove is available which an on-site operator wears to remotely inspect a fixing state of an apparatus.

With an existing glove, it is possible to measure a change in a force applied to a contact surface, and vibration of a fingertip. However, information such as a position and posture of a target object relative to the glove, and a position of the fingertip on the target object cannot be obtained. For this reason, it is not possible to get information such as an orientation of the force acting on the target object and an exact displacement of the target object.

Patent Literature 1 discloses a robot-hand finger in which in order to sense contact with a target object, a CCD camera is set on an inner side of a fingertip portion covered with an elastic body, thereby measuring elastic-body deformation.

### CITATION LIST

### Patent Literature

Patent Literature 1: JP 2010-221359 A

### SUMMARY OF INVENTION

### Technical Problem

To inspect a fixing state of an apparatus such as rattling of the apparatus, an on-site operator wears a glove and performs an operation such as gripping a target object with the glove and applying vibrations to it.

At this time, by accurately grasping a position of a fingertip on the target object, the fixing state can be determined with higher precision.

Even if the technique of Patent Literature 1 is applied to the glove, a contact position of a fingertip on the target object cannot be correctly obtained, so it is not possible to get information such as an orientation of a force acting on the target object and an exact displacement of the target object. This poses a problem that the fixing state of the target object cannot be determined with high precision.

The present disclosure has as its objective to determine a fixing state of a target object with higher precision by accurately obtaining a contact position of a fingertip on the target object.

### Solution to Problem

A fixing-state determination system according to the present disclosure which comprises a glove an operator wears to grip a target object and which determines a fixing state of the target object, comprises:
a photographing device placed at a position of the glove that corresponds to a portion between a pair of fingers which grip the target object, to photograph the target object gripped by the pair of fingers as a target image;
a position-and-posture estimation unit to estimate a position and posture of the target object by using the target image;
a range calculation unit to analyze movement of a fingertip of the operator by using the target image, and to calculate a fingertip movement range which is a movement range of a position of a fingertip of each finger of the operator;
a contact position calculation unit to calculate a contact position of the fingertip on the target object on a basis of the position and posture of the target object and the fingertip movement range; and
a determination unit to determine the fixing state of the target object on a basis of displacement of the target object and excitation force information which is information of an excitation force at the contact position of the fingertip for the target object.

### Advantageous Effects of Invention

An objective of the present disclosure is to determine a fixing state of a target object with higher precision by correctly obtaining a contact position of a fingertip on the target object.

### BRIEF DESCRIPTION OF DRAWINGS

FIG. 1 is a diagram illustrating an overall configuration example of a fixing-state determination system according to Embodiment 1.

FIG. 2 is a diagram illustrating a configuration example of an information processing device according to Embodiment 1.

FIG. 3 is a diagram illustrating a configuration example of a glove according to Embodiment 1.

FIG. 4 is a diagram illustrating a situation where the glove according to Embodiment 1 grips a target object.

FIG. 5 is a flowchart illustrating an operation example of the fixing-state determination system according to Embodiment 1.

FIG. 6 is a diagram illustrating an example of a target image according to Embodiment 1.

FIG. 7 is a diagram illustrating an idea of an angle of a proximal phalanx of each finger in a range calculation process according to Embodiment 1.

FIG. 8 is a diagram illustrating an idea of a fingertip movement range in the range calculation process according to Embodiment 1.

FIG. 9 is a diagram illustrating an idea of a contact position in a contact position calculation process according to Embodiment 1.

FIG. 10 is a diagram illustrating a configuration example of a glove according to Modification 1 of Embodiment 1.

FIG. 11 is a diagram illustrating a configuration example of a glove according to Modification 2 of Embodiment 1.

FIG. 12 is a diagram illustrating a configuration example of a glove according to Modification 3 of Embodiment 1.

FIG. 13 is a diagram illustrating a configuration example of a glove according to Modification 4 of Embodiment 1.

FIG. 14 is a diagram illustrating a configuration example of an information processing device according to Modification 5 of Embodiment 1.

### DESCRIPTION OF EMBODIMENTS

The present embodiment will be described below with referring to drawings. In the drawings, the same or equivalent portions are denoted by the same reference sign. In description of the embodiment, explanation on the same or equivalent portions will be appropriately omitted or simplified. Arrows in the drawings mainly indicate data flows or process flows. In the drawings below, a dimensional relationship among constituent members may be different from an actual relationship. Also, in description of the embodiments, an orientation or position such as up, down, left, right, front, and rear may be indicated. These representations are employed for descriptive convenience sake and are not intended to limit positioning, orientation, and direction of devices, tools, components, and so on.

### Embodiment 1

### ***Description of Configurations***

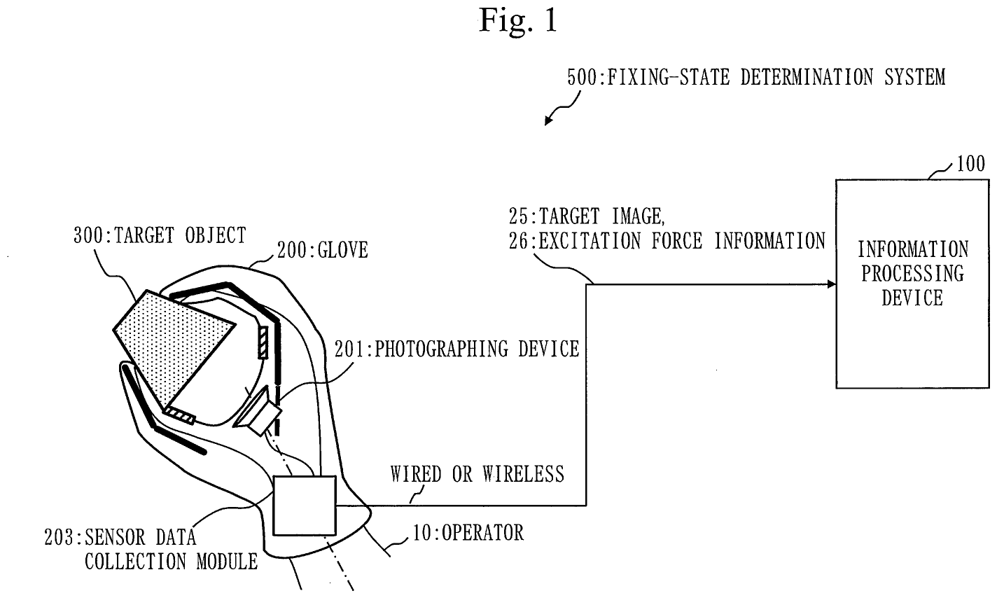

FIG. 1 is a diagram illustrating an overall configuration example of a fixing-state determination system 500 according to the present embodiment.

The fixing-state determination system 500 is a system according to which an operator 10 wears a glove, grips a target object 300, and applies an excitation force to the target object 300, thereby determining a fixing state of the target object 300.

The fixing-state determination system 500 is provided with a glove 200 the operator 10 wears to grip the target object 300, and an information processing device 100 which communicates with the glove 200. Communication between the glove 200 and the information processing device 100 may be either wired or wireless.

Detailed configurations of the information processing device 100 and glove 200 will be described below.

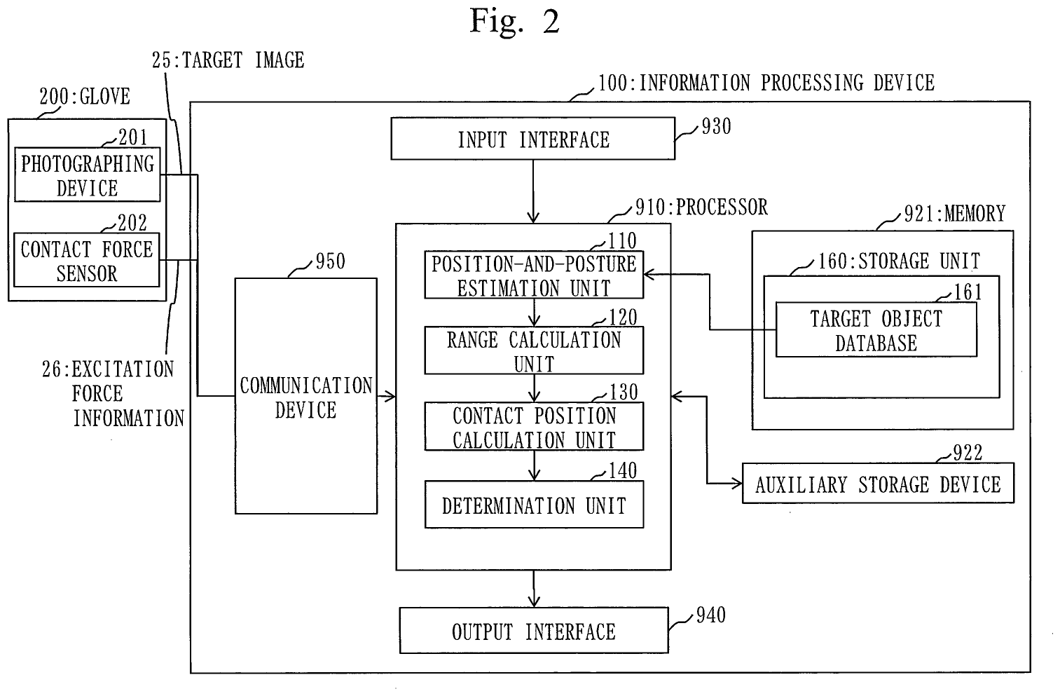

FIG. 2 is a diagram illustrating a configuration example of the information processing device 100 according to the present embodiment.

The information processing device 100 is a computer. The information processing device 100 is provided with a processor 910 as well as other hardware devices such as a memory 921, an auxiliary storage device 922, an input interface 930, an output interface 940, and a communication device 950. The processor 910 is connected to the other hardware device by wired communication or wireless communication and controls the other hardware devices.

The information processing device 100 is provided with a position-and-posture estimation unit 110, a range calculation unit 120, a contact position calculation unit 130, a determination unit 140, and a storage unit 160, as function elements. A target object database 161 is stored in the storage unit 160.

Functions of the position-and-posture estimation unit 110, range calculation unit 120, contact position calculation unit 130, and determination unit 140 are implemented by software. The storage unit 160 is provided to the memory 921. The storage unit 160 may be provided to the auxiliary storage device 922, or may be provided to the memory 921 and the auxiliary storage device 922 by distribution.

The processor 910 is a device that runs a fixing-state determination program. The fixing-state determination program is a program that implements the functions of the position-and-posture estimation unit 110, range calculation unit 120, contact position calculation unit 130, and determination unit 140. Note that the fixing-state determination program includes a program that implements a function of the glove to be described later.

The processor 910 is an IC that performs computation processing. Specific examples of the processor 910 are a CPU, a DSP, and a GPU. Note that IC stands for Integrated Circuit; CPU for Central Processing Unit; DSP for Digital Signal Processor; and GPU for Graphics Processing Unit.

The memory 921 is a storage device that stores data temporarily. A specific example of the memory 921 is an SRAM or a DRAM. Note that SRAM stands for Static Random-Access Memory; and DRAM for Dynamic Random-Access Memory.

The auxiliary storage device 922 is a storage device that keeps data. A specific example of the auxiliary storage device 922 is an HDD. The auxiliary storage device 922 may be a portable storage medium such as an SD (registered trademark) memory card, a CF, a NAND flash, a flexible disk, an optical disk, a compact disk, a Blu-ray (registered trademark) disc, and a DVD. Note that HDD stands for Hard Disk Drive; SD (registered trademark) for Secure Digital; CF for CompactFlash (registered trademark); and DVD for Digital Versatile Disk.

The input interface 930 is a port to be connected to an input device such as a mouse, a keyboard, and a touch panel. The input interface 930 is specifically a USB terminal. The input interface 930 may be a port to be connected to a LAN. Note that USB stands for Universal Serial Bus; and LAN for Local Area Network.

The output interface 940 is a port to which a cable of an output apparatus such as a display is to be connected. The output interface 940 is specifically a USB terminal or an HDMI (registered trademark) terminal. The display is specifically an LCD. The output interface 940 is also called a display unit interface. Note that HDMI (registered trademark) stands for High Definition Multimedia Interface; and LCD for Liquid Crystal Display.

The communication device 950 has a receiver and a transmitter. The communication device 950 is connected to a communication network such as a LAN, the Internet, a WiFi (registered trademark), and a telephone line. The communication device 950 is specifically a communication chip or an NIC. Note that NIC stands for Network Interface Card.

The fixing-state determination program is run in the information processing device 100. The fixing-state determination program is read by the processor 910 and run by the processor 910. Not only the fixing-state determination program but also an OS is stored in the memory 921. Note that OS stands for Operating System. The processor 910 runs the fixing-state determination program while running the OS. Note that the fixing-state determination program and the OS may be stored in the auxiliary storage device 922. The fixing-state determination program and OS stored in the auxiliary storage device 922 are loaded to the memory 921 and run by the processor 910. The fixing-state determination program may be incorporated in the OS partly or entirely.

The information processing device 100 may be provided with a plurality of processors that substitute for the processor 910. The plurality of processors share running of the fixing-state determination program. Each processor is a device that runs the fixing-state determination program just as the processor 910 does.

Data, information, signal values, and variable values which are utilized, processed, or outputted by the fixing-state determination program are stored in the memory 921, the auxiliary storage device 922, or a register or cache memory in the processor 910.

The word “unit” in each of the terms: position-and-posture estimation unit 110; range calculation unit 120; contact position calculation unit 130; and determination unit 140 may be replaced by “circuit”, “stage”, “procedure”, “process”, or “circuitry”. The fixing-state determination program causes the computer to execute a position-and-posture estimation process, a range calculation process, a contact position calculation process, a determination process, and an image setting process. The word “process” in each of the terms: position-and-posture estimation process; range calculation process; contact position calculation process; and determination process may be replaced by “program”, “program product”, “program-stored computer readable storage medium”, or “program-recorded computer readable recording medium”. A fixing-state determination method is a method that is executed by the information processing device 100 running the fixing-state determination program.

The fixing-state determination program may be presented as being stored in a computer readable recording medium. Alternatively, the fixing-state determination program may be presented as a program product.

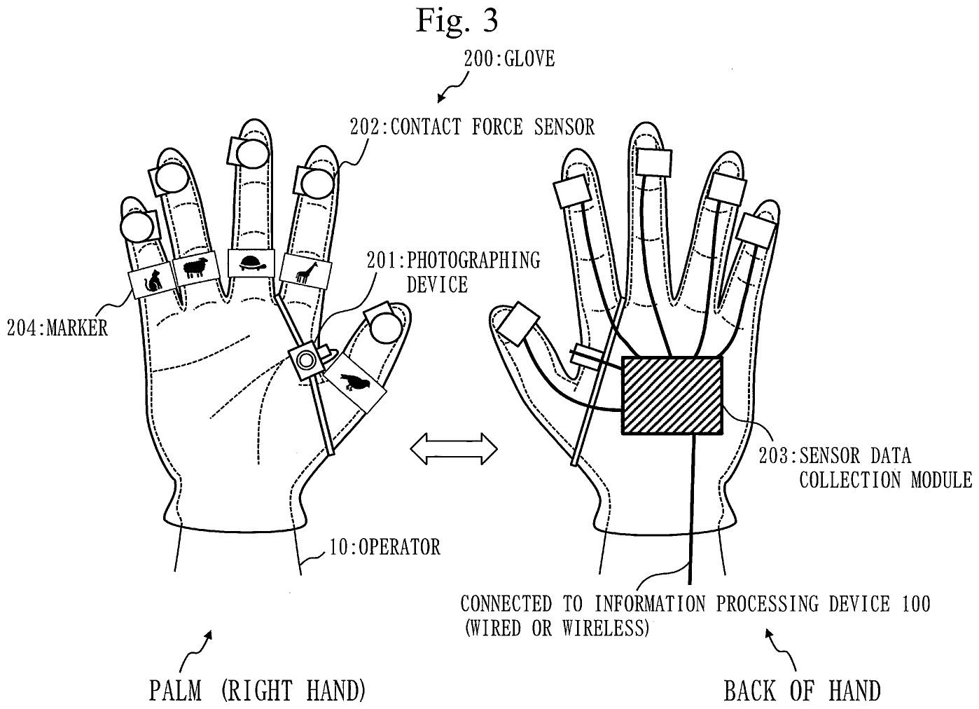

FIG. 3 is a diagram illustrating a configuration example of the glove 200 according to the present embodiment.

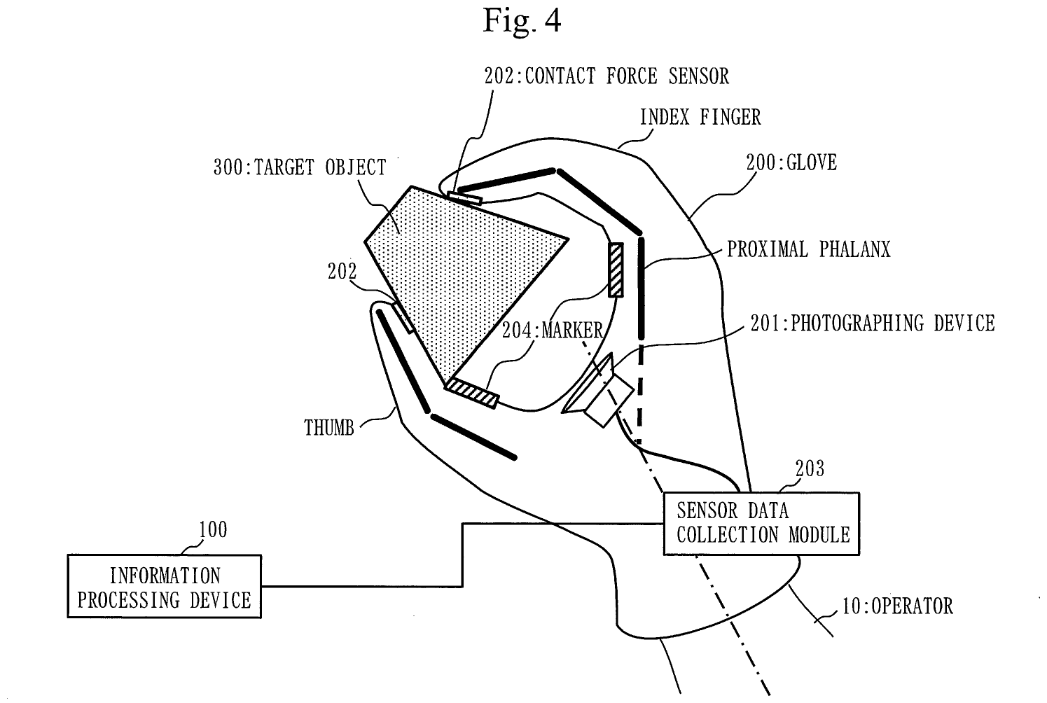

FIG. 4 is a diagram illustrating a situation where the glove 200 according to the present embodiment grips the target object 300.

When the operator 10 is to grip the target object 300 and to apply an excitation force to it, the glove 200 is put on a hand of the operator 10 who is to grip the target object 300.

FIG. 3 illustrates the glove 200 worn on the right hand of the operator 10. The left part of FIG. 3 illustrates the glove 200 seen from the palm. The right part of FIG. 3 illustrates the glove 200 seen from the back of the hand.

FIG. 4 illustrates how the operator 10 wears the glove 200 to grip the target object 300.

The glove 200 is provided with a photographing device 201, contact force sensors 202, a sensor data collection module 203, and markers 204.

The photographing device 201 is placed at a position of the glove 200 that corresponds to a portion between a pair of fingers which grip the target object 300, and photographs the target object 300 gripped by the pair of fingers as a target image 25.

The photographing device 201 is, for example, a device formed by placing a module having an optical image sensor on a substrate. The photographing device 201 is, for example, a CCD camera.

Usually, people grip an object with using a thumb and a finger other than the thumb. In FIG. 3, the operator 10 grips the object with using fingers including a thumb and an index finger. Hence, the photographing device 201 is placed at a position of the glove 200 that corresponds to a palm-side portion between the thumb and the index finger. Any other position will do as far as it is where the gripped target object 300 is to be photographed. The photographing device 201 may be placed at a root of one finger. Alternatively, the photographing device 201 may be placed near a center of the palm.

The marker 204 is placed at a position of the glove 200 that corresponds to an inner side of a proximal phalanx of each finger of the operator 10. Specifically, the marker 204 is printed at a position of the glove 200 that corresponds to an inner side of a proximal phalanx of each finger of the operator 10.

The photographing device 201 photographs the target image 25 including the position of the marker of when the glove 200 grips the target object. That is, the target image 25 includes the marker 204 printed on each finger of the pair of fingers.

Each contact force sensor 202 is placed at a position of the glove 200 that corresponds to the inner side of the fingertip of the operator 10. The contact force sensor 202 acquires information of an excitation force for the target object 300 as excitation force information 26. The excitation force information 26 expresses, for example, a magnitude of the excitation force.

The sensor data collection module 203 collects various types of sensor data and transmits the data to the information processing device 100. Specifically, the sensor data collection module 203 collects the target image 25 from the photographing device 201 and the excitation force information 26 from the contact force sensor 202. Then, the sensor data collection module 203 transmits the target image 25 and the excitation force information 26 to the information processing device 100 by wired communication or wireless communication.

The sensor data collection module 203 is a computer that collects sensor data such as the target image 25 and the excitation force information 26 and transmits the sensor data to the information processing device 100.

For example, the information processing device 100 is provided with hardware devices such as an input interface for inputting the sensor data, a processor, and a communication device to communicate with the information processing device 100. Explanation of each hardware is the same as the explanation of the information processing device 100.

### *** Description of Operations***

Operations of the fixing-state determination system 500 according to the present embodiment will now be described. An operation procedure of the fixing-state determination system 500 corresponds to the fixing-state determination method. A program that implements the operations of the fixing-state determination system 500 corresponds to the fixing-state determination program.

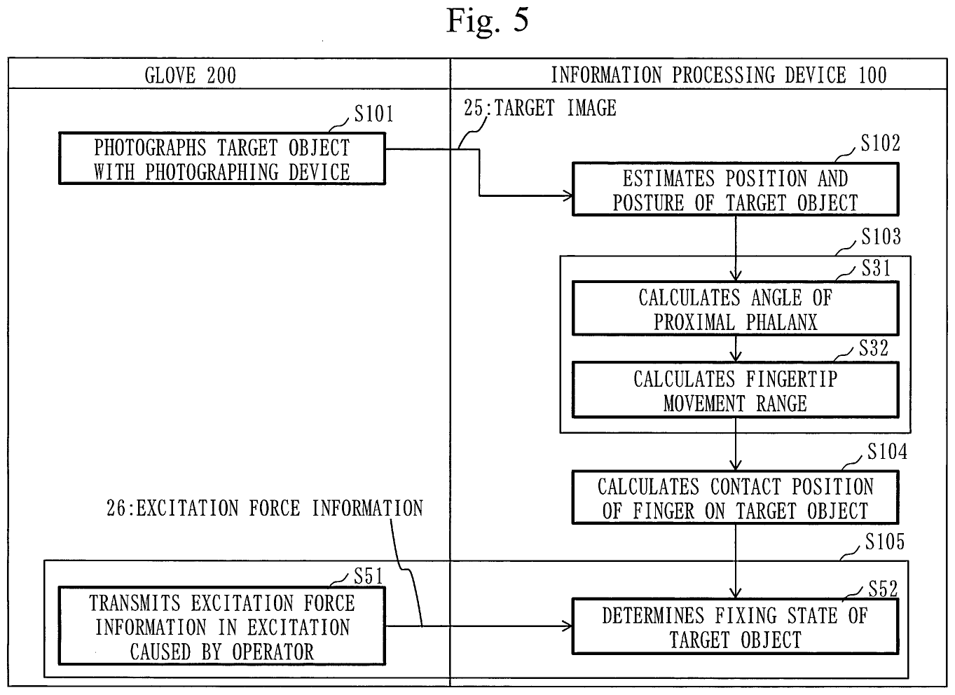

FIG. 5 is a flowchart illustrating an operation example of the fixing-state determination system 500 according to the present embodiment.

### <Photographing Process>

In step S101, the photographing device 201 photographs the target object 300 gripped by a pair of fingers as the target image 25.

Specifically, the photographing device 201 performs photographing to include the target object 300 gripped by the pair of fingers as well as the markers 204 printed on the individual fingers of the pair of fingers.

The sensor data collection module 203 transmits the target image 25 to the information processing device 100.

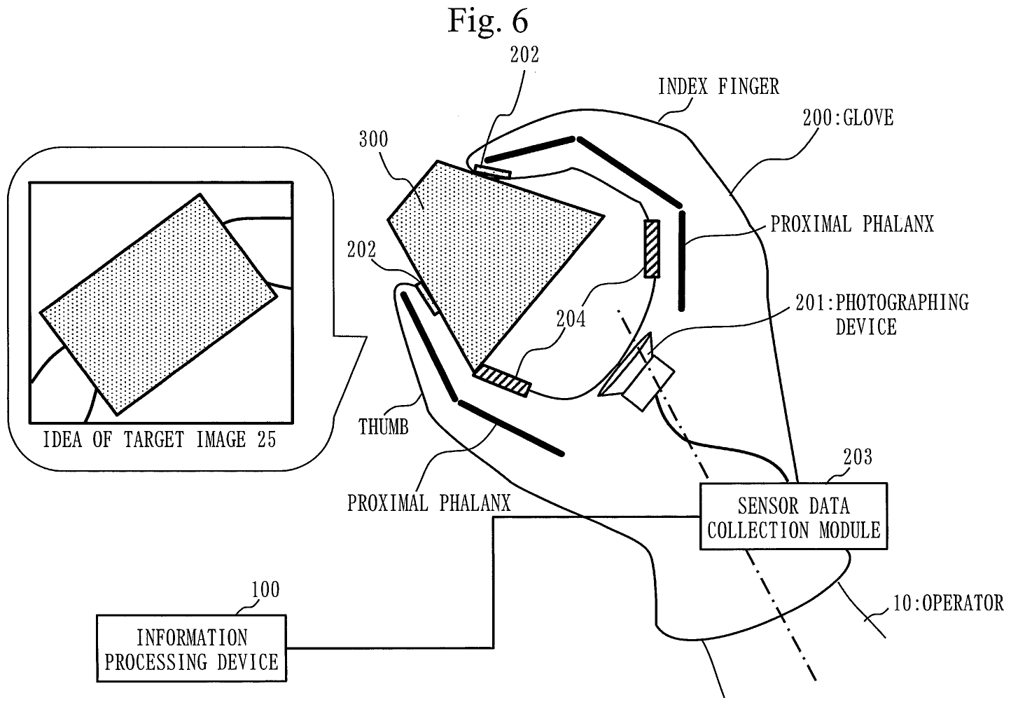

FIG. 6 is a diagram illustrating an example of the target image 25 by means of the photographing device 201 according to the present embodiment.

As illustrated in FIG. 6, depending on the shape of the target object 300, contact portions of the target object 300 with the fingertips cannot be photographed.

Although not illustrated, the target image 25 includes the markers 204 printed on the individual fingers of the pair of fingers.

### <Position-and-Posture Estimation Process>

In step S102, the position-and-posture estimation unit 110 estimates the position and posture of the target object 300 by using the target image 25. The position-and-posture estimation unit 110 compares the target image 25 with image candidates 61 accumulated in the target object database 161, thereby estimating the position and posture of the target object 300.

Specifically, this is as follows.

Individual images of a plurality of combinations of the position and posture of the target object 300 are accumulated in the target object database 161 as the image candidates 61.

The image candidates 61 are a plurality of pieces of three-dimensional data obtained by photographing the target object 300 in combinations of various angles and various positions.

The position-and-posture estimation unit 110 compares the target image 25 with the image candidates 61 and selects an image candidate 61 having a highest similarity, thereby estimating the position and posture of the target object 300 in the target image 25.

### <Range Calculation Process>

In step S103, the range calculation unit 120 analyzes movement of a fingertip of the operator 10 by using the target image 25, and calculates a fingertip movement range R which is a movement range of a position of the fingertip of each finger of the operator. Step S103 includes step S31 and step S32.

Specifically, this is as follows.

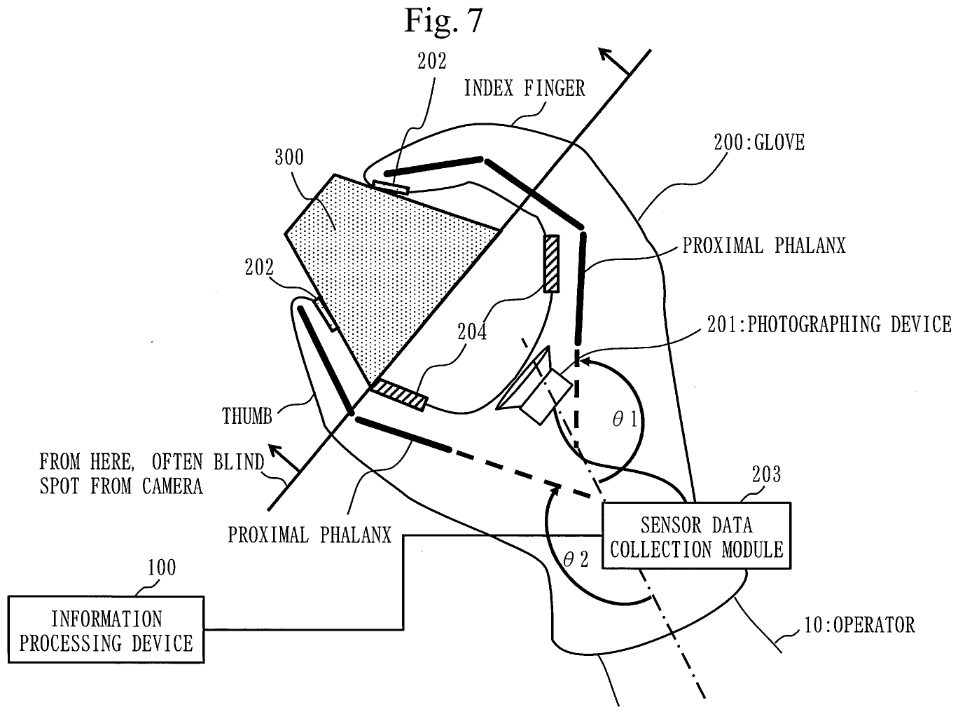

FIG. 7 is a diagram illustrating an idea of an angle of a proximal phalanx of each finger in the range calculation process according to the present embodiment.

In step S31, the range calculation unit 120 calculates the angle of the proximal phalanx of each finger of the operator 10 by using the position of the marker 204 on the proximal phalanx in the target image 25. The example of FIG. 7 shows how an angle θ1 of the proximal phalanx of the thumb and an angle θ2 of the proximal phalanx of the index finger are calculated.

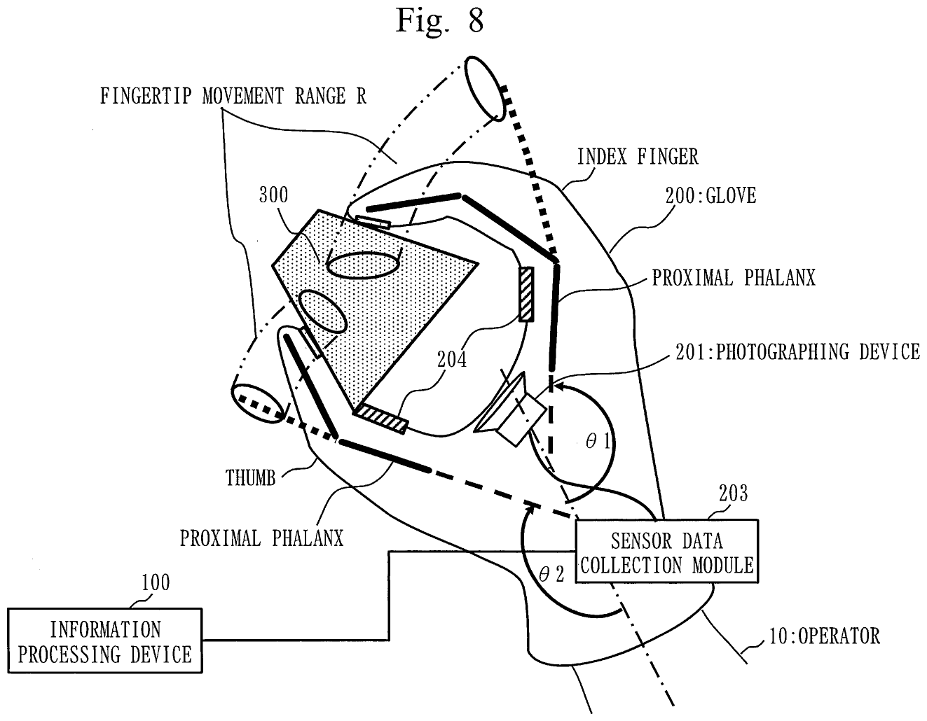

FIG. 8 is a diagram illustrating an idea of fingertip a movement range R in the range calculation process according to the present embodiment.

In step S32, the range calculation unit 120 calculates the fingertip movement range R on a basis of the angle of the proximal phalanx of each finger of the operator 10. The range calculation unit 120 calculates the fingertip movement range R of each finger on a basis of the angle of the proximal phalanx of the finger by using information on a joint structure of the finger in an ordinary state.

### <Contact Position Calculation Process>

In step S104, the contact position calculation unit 130 calculates a contact position P of the fingertip on the target object 300 on a basis of the position and posture of the target object 300 and the fingertip movement range R.

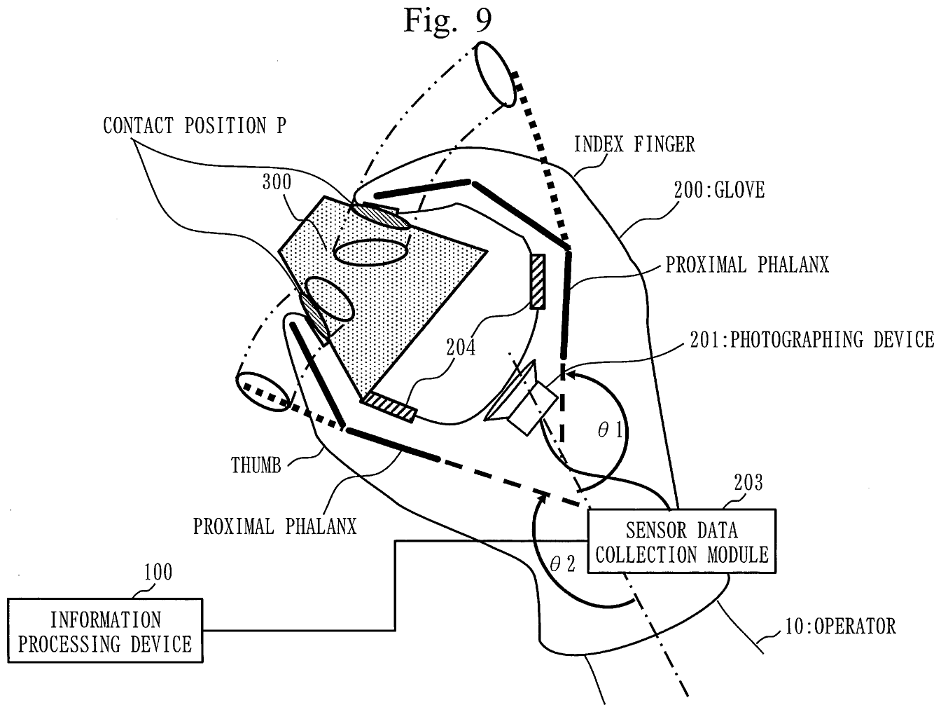

FIG. 9 is a diagram illustrating an idea of the contact position P in the contact position calculation process according to the present embodiment.

The contact position calculation unit 130 calculates a surface position of the target object 300 from the position and posture of the target object 300. Then, the contact position calculation unit 130 calculates the contact position P between the target object 300 and the fingertip from an intersection of the surface position of the target object 300 and the fingertip movement range R.

### <Determination Process>

In step S105, the determination unit 140 determines the fixing state of the target object 300 on a basis of displacement of the target object 300 and the excitation force information 26 which is information of the excitation force at the contact position P of the fingertip for the target object 300. Step S105 includes step S51 and step S52.

Specifically, this is as follows.

In step S51, the operator 10 puts on the glove 200, grips the target object 300, and applies the excitation force to the target object 300. The sensor data collection module 203 transmits a magnitude of the excitation force acquired by the contact force sensors to the information processing device 100 as the excitation force information 26. The excitation force information 26 is acquired by the contact force sensors 202 and transmitted from the glove 200 to the information processing device 100 via the sensor data collection module 203.

In step S52, the determination unit 140 determines the fixing state of the target object 300 on a basis of the contact position P, the excitation force information 26, and the displacement of the target object 300.

The displacement of the target object 300 is acquired from the target image 25 by the determination unit 140.

The determination unit 140 calculates the magnitude of the excitation force and the orientation of the excitation force at the contact position P, acquires the displacement being a response of the target object 300, and integrates these calculation results, thereby determining the fixing state or fixing situation of the target object 300.

As described above, the fixing state can be evaluated as an indicator with using a relationship between the displacement of the target object 300 and the excitation force.

### *** Other Configurations***

### <Modification 1>

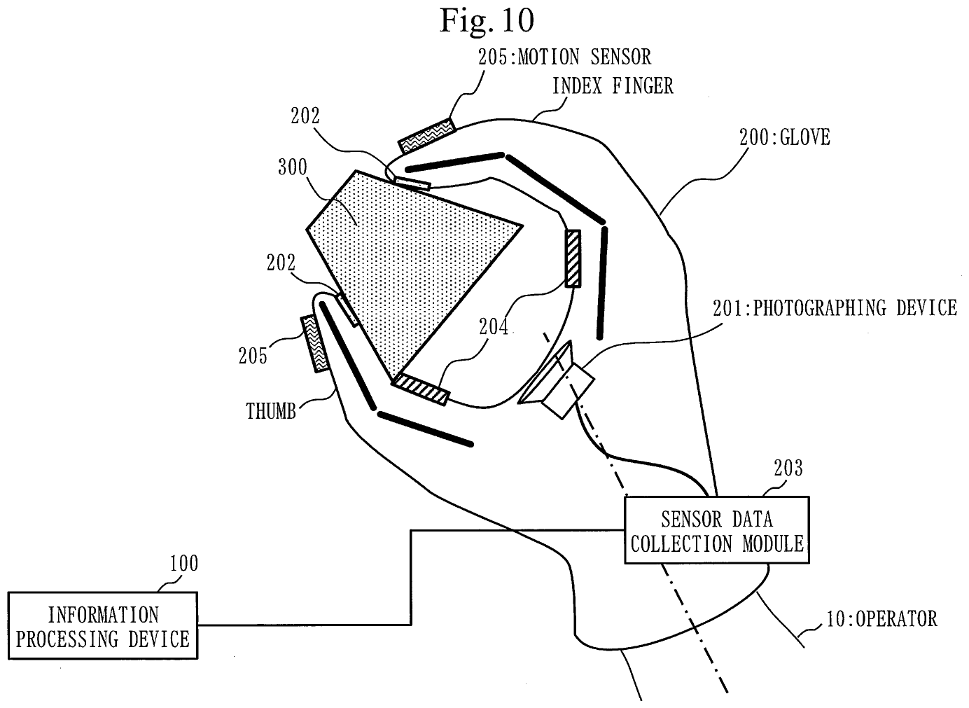

FIG. 10 is a diagram illustrating a configuration example of a glove 200 according to Modification 1 of the present embodiment.

The glove 200 may be provided with a motion sensor on an outer side of a fingertip of each finger of an operator 10 to detect movement of the fingertip.

A range calculation unit 120 calculates a fingertip movement range R on a basis of an angle of a proximal phalanx of each finger of the operator 10 and the movement of the fingertip detected by a motion sensor 205.

The motion sensor 205 is, for example, an acceleration sensor that can measure acceleration. The range calculation unit 120 estimates a fingertip position from an amount of displacement from an initial position. A number of motion sensors to be utilized may be changed in consideration of variations of an assumed gripping method.

With the glove 200 according to Modification 1, a position estimation precision of the fingertip improves, and an excitation position can be estimated accurately and stably.

### <Modification 2>

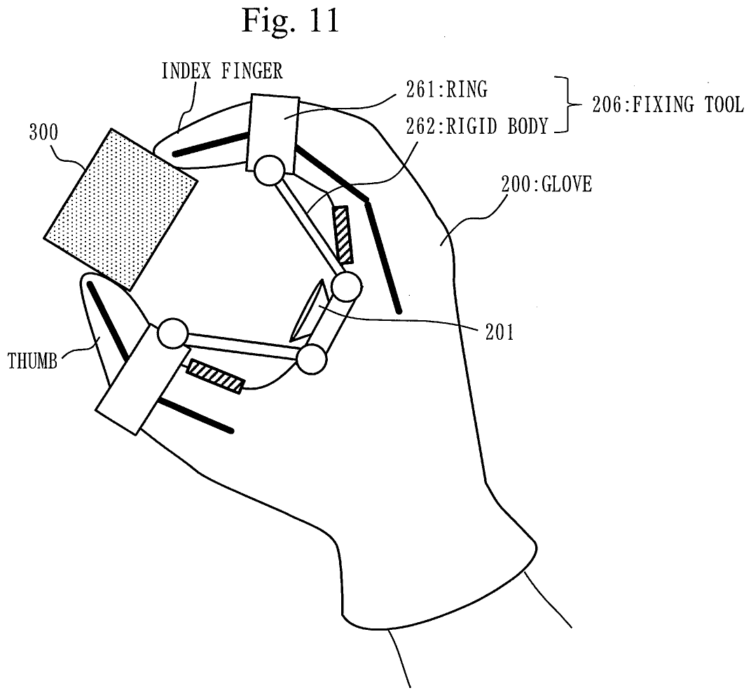

FIG. 11 is a diagram illustrating a configuration example of a glove 200 according to Modification 2 of the present embodiment.

The glove 200 may be provided with a fixing tool 206 equipped at each finger of a pair of fingers of the glove 200 to fix a photographing device 201. The fixing tool 206 is provided with, for example, a ring 261 equipped at each finger of the pair of fingers of the glove 200, and a rigid body 262 which connects the ring 261 with the photographing device 201.

With the glove 200 according to Modification 2, since the ring 261 fixed to the finger and the photographing device 201 are connected to each other with the rigid body 262, a position estimation precision of the finger and the photographing device 201 improves, and the estimation precision of the fingertip position also improves.

### <Modification 3>

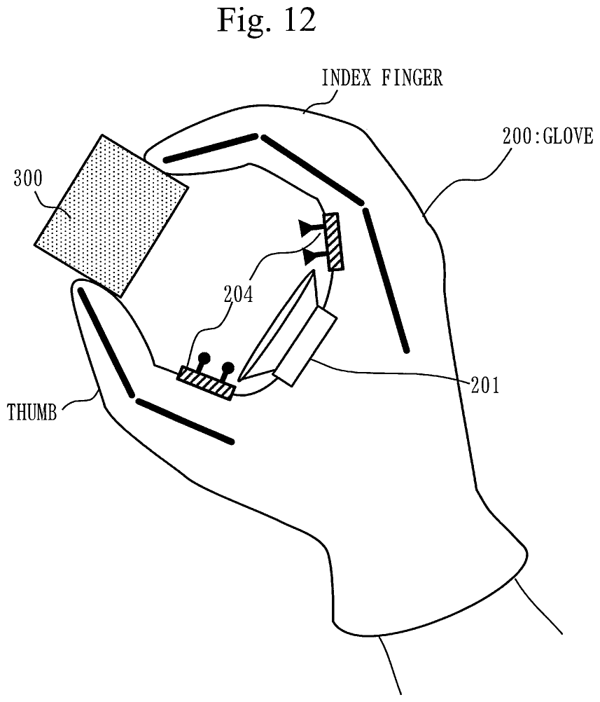

FIG. 12 is a diagram illustrating a configuration example of a glove 200 according to Modification 3 of the present embodiment.

Each marker 204 may have a projecting shape.

As the markers corresponding to proximal phalanxes, three-dimensional objects having different shapes among fingers may be formed or fixed on a surface of the glove. When a projection having a characteristic projecting shape is used as a position-detection marker to be set on a palm side of the proximal phalanx, an angle range of the proximal phalanx, a marker for which can be detected by a camera, is widened, so the fingertip position can be estimated more stably.

### <Modification 4>

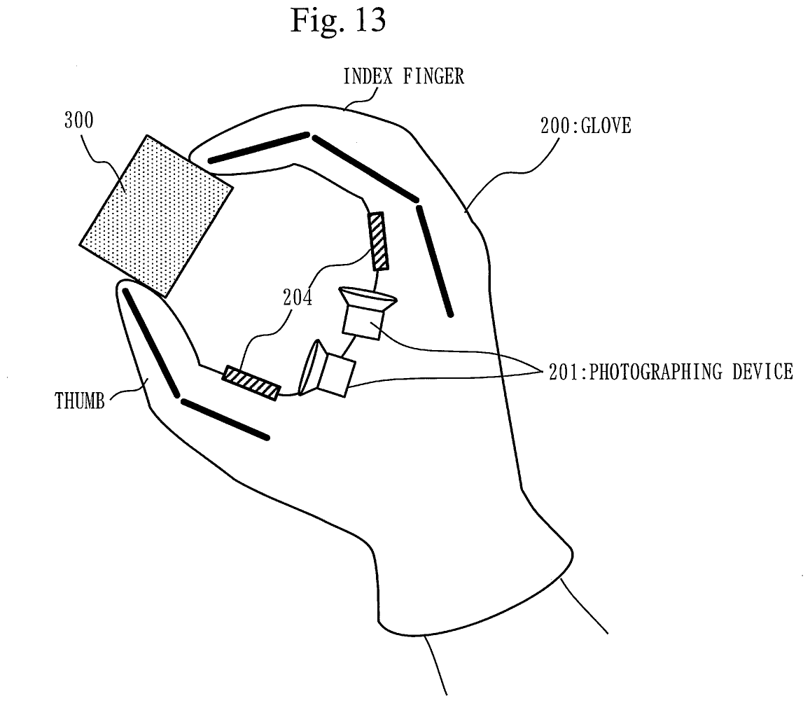

FIG. 13 is a diagram illustrating a configuration example of a glove 200 according to Modification 4 of the present embodiment.

The glove may be provided with a plurality of photographing devices 201. That is, a plurality of cameras may be set on the glove. When two or more camera modules are placed on the glove as optical image sensors, an angle range where the cameras can detect the markers is widened, so the fingertip position can be estimated more stably.

### <Modification 5>

In the present embodiment, the functions of the position-and-posture estimation unit 110, range calculation unit 120, contact position calculation unit 130, and determination unit 140 are implemented by software. According to a modification, the functions of the position-and-posture estimation unit 110, range calculation unit 120, contact position calculation unit 130, and determination unit 140 may be implemented by hardware.

Specifically, a fixing-state determination system 500 is provided with an electronic circuit 909 in place of a processor 910.

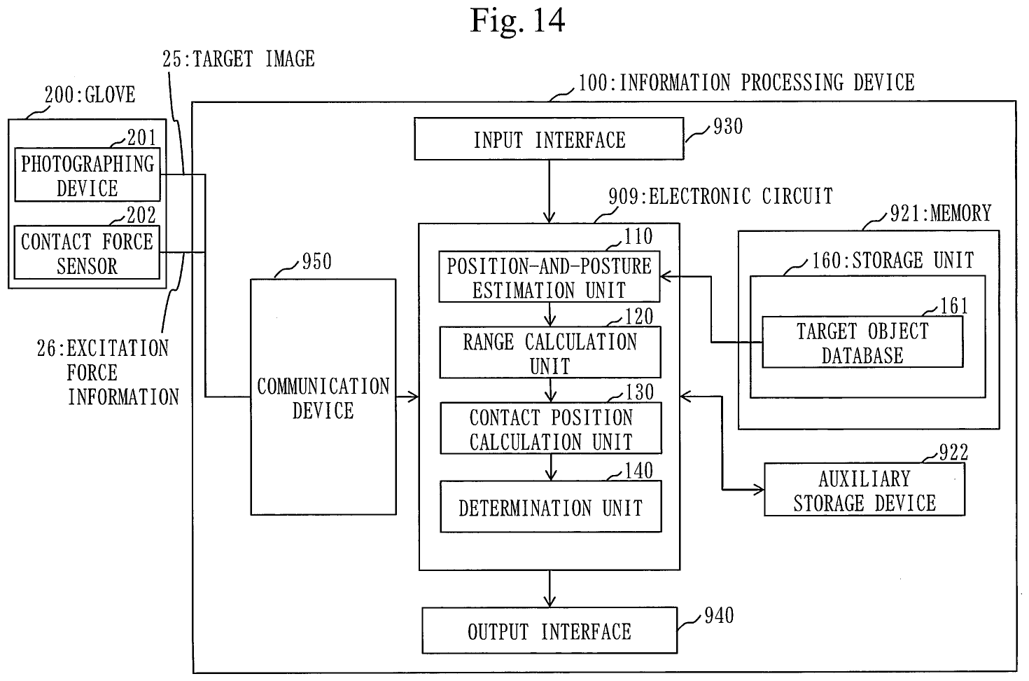

FIG. 14 is a diagram illustrating a configuration example of an information processing device 100 according to Modification 5 of the present embodiment.

The electronic circuit 909 is a dedicated electronic circuit that implements the functions of the position-and-posture estimation unit 110, range calculation unit 120, contact position calculation unit 130, and determination unit 140. The electronic circuit 909 is specifically a single circuit, a composite circuit, a programmed processor, a parallel-programmed processor, a logic IC, a GA, an ASIC, or an FPGA. Note that GA stands for Gate Array; ASIC for Application Specific Integrated Circuit; and FPGA for Field-Programmable Gate Array.

The functions of the position-and-posture estimation unit 110, range calculation unit 120, contact position calculation unit 130, and determination unit 140 may be implemented by one electronic circuit, or may be implemented by a plurality of electronic circuits by distribution.

According to another modification, some of the functions of the position-and-posture estimation unit 110, range calculation unit 120, contact position calculation unit 130, and determination unit 140 may be implemented by an electronic circuit, and the remaining functions may be implemented by software. Also, some or all of the functions of the position-and-posture estimation unit 110, range calculation unit 120, contact position calculation unit 130, and determination unit 140 may be implemented by firmware.

The processor and the electronic circuit are also called processing circuitry. That is, the functions of the position-and-posture estimation unit 110, range calculation unit 120, contact position calculation unit 130, and determination unit 140 are implemented by processing circuitry.

The description for Modification 5 also applies to the computer mounted in the glove 200.

### *** Description of Effect of Embodiment***

In the fixing-state determination system according to the present embodiment, the on-site operator puts on a glove having a contact force sensor, grips a target object, and applies an excitation force to the target object. Haptic information is presented to a person in charge of testing located at a remote location on a basis of thus-acquired sensor information.

For example, when gripping an object with a robot hand, with a hand-eye system that detects an object position by a camera attached to a robot hand unit, fingertips in gripping enter a dead angle formed by the target object, so the positions of the fingertips cannot be determined. Therefore, an application position and orientation of an excitation force applied by the fingers to the target object cannot be obtained, and accordingly the determination precision might be decreased.

On the other hand, with a fixing-state determination system according to the present embodiment, the contact positions of the fingertips on the target object can be obtained accurately. Thus, information such as an orientation of a force acting on the target object and an exact displacement of the target object can be obtained accurately. As a result, a fixing state of the target object can be determined at high precision.

The fixing-state determination system according to the present embodiment utilizes a glove in which markers that differ from a finger to a finger are printed at portions of the palm side that correspond to the bones at the roots of the fingers (proximal phalanxes). In the glove, a compact camera are built in a space between the thumb and the index finger. Then, the following processes are executed.
(1) A position of the target object is calculated by the camera by utilizing shape data of an inspection target.
(2) An angle of the proximal phalanx of each finger is calculated from the marker displayed on the camera.
(3) A range that is a candidate of a fingertip position is calculated on a basis of angle information of the proximal phalanx.
(4) A contact position is calculated from a relationship between position-and-shape information of the target object and the candidate of the fingertip position.
(5) A change in a three-dimensional excitation force is calculated from a change in fingertip contact position and a change in contact force information which are obtained during an exciting operation, and the calculated change is integrated with information of displacement of the target object, so as to calculate the fixed state of the target object.

As described above, with the fixing-state determination system according to the present embodiment, a fingertip position estimation precision is improved, so the excitation position can be estimated accurately and stably.

In Embodiment 1 described above, the individual units of the fixing-state determination system are described as independent function blocks. However, the configuration of the fixing-state determination system is not limited to a configuration like that in the above-described embodiment. The function blocks of the fixing-state determination system may have any configurations as far as they can implement the functions explained in the embodiment described above. The fixing-state determination system may be a system formed of a plurality of devices instead of one device.

A plurality of portions of Embodiment 1 may be practiced in combination. Alternatively, one portion of the embodiment may be practiced. The embodiment may be practiced entirely or partially by any combination.

That is, in Embodiment 1, the individual embodiments can be combined feely; an arbitrary constituent element of each embodiment can be deformed; or an arbitrary constituent element of each embodiment can be omitted.

The embodiment described above is an essentially preferable exemplification, and is not intended to limit the scope of the present disclosure, the scope of applied products of the present disclosure, and a range of usage of the present disclosure. Various changes can be made in the embodiment described above as necessary. For example, the procedures described with using flowcharts or sequence diagrams may be changed appropriately.

### REFERENCE SIGNS LIST

10: operator; 25: target image; 26: excitation force information; 61: image candidate; 100: information processing device; 110: position-and-posture estimation unit; 120: range calculation unit; 130: contact position calculation unit; 140: determination unit; 160: storage unit; 161: target object database; 200: glove; 201: photographing device; 202: contact force sensor; 203: sensor data collection module; 204: marker; 205: motion sensor; 206: fixing tool; 261: ring; 262: rigid body; 300: target object; 500: fixing-state determination system; 909: electronic circuit; 910: processor; 921: memory; 922: auxiliary storage device; 930: input interface; 940: output interface; 950: communication device.

1. A fixing-state determination system which comprises a glove an operator wears to grip a target object and which determines a fixing state of the target object, the fixing-state determination system comprising:
a photographing device placed at a position of the glove that corresponds to a portion between a pair of fingers which grip the target object, to photograph the target object gripped by the pair of fingers as a target image; and
processing circuitry
to estimate a position and posture of the target object by using the target image,
to analyze movement of a fingertip of the operator by using the target image, and to calculate a fingertip movement range which is a movement range of a position of a fingertip of each finger of the operator,
to calculate a contact position of the fingertip on the target object on a basis of the position and posture of the target object and the fingertip movement range, and
to determine the fixing state of the target object on a basis of displacement of the target object and excitation force information which is information of an excitation force at the contact position of the fingertip for the target object.

2. The fixing-state determination system according to claim 1,
wherein the glove comprises a marker at a position corresponding to an inner side of a proximal phalanx of each finger of the operator,
wherein the photographing device photographs the target image including the position of the marker of when the glove grips the target object, and
wherein the processing circuitry calculates an angle of the proximal phalanx of each finger of the operator by using the position of the marker in the target image, and calculates the fingertip movement range on a basis of the angle of the proximal phalanx of each finger of the operator.

3. The fixing-state determination system according to claim 2,
wherein the glove comprises a motion sensor on an outer side of the fingertip of each finger of the operator to detect movement of the fingertip, and
wherein the processing circuitry calculates the fingertip movement range on a basis of the angle of the proximal phalanx of each finger of the operator and the movement of the fingertip detected by the motion sensor.

4. The fixing-state determination system according to claim 1, comprising
a target object database in which individual images of a plurality of combinations of the position and posture of the target object are accumulated as image candidates,
wherein the processing circuitry compares the target image with the image candidates accumulated in the target object database, thereby estimating the position and posture of the target object.

5. The fixing-state determination system according to claim 1,
wherein the glove comprises a contact force sensor at a position corresponding to an inner side of the fingertip of the operator, and
wherein the processing circuitry acquires the excitation force at the contact position of the fingertip for the target object from the contact force sensor, and acquires displacement of the target object from the target image.

6. A glove provided to a fixing-state determination system which comprises the glove an operator wears to grip a target object, and an information processing device to communicate with the glove, the fixing-state determination system determining a fixing state of the target object,
the glove comprising:
a photographing device placed at a position corresponding to a portion between a pair of fingers which grip the target object, to photograph the target object gripped by the pair of fingers as a target image; and
a communication device to transmit to the information processing device the target image, the information processing device estimating a position and posture of the target object by using the target image; calculating a fingertip movement range which is a movement range of a position of a fingertip of each finger of the operator by using the target image; and calculating a contact position of the fingertip on the target object on a basis of the position and posture of the target object and the fingertip movement range.

7. The glove according to claim 6, comprising
a marker at a position corresponding to an inner side of a proximal phalanx of each finger of the operator,
wherein the photographing device photographs the target image including the position of the marker of when the glove grips the target object, and
wherein the image processing device calculates an angle of the proximal phalanx of each finger of the operator by using the position of the marker in the target image, and calculates the fingertip movement range on a basis of the angle of the proximal phalanx of each finger of the operator.

8. The glove according to claim 7, comprising
a motion sensor on an outer side of the fingertip of each finger of the operator to detect movement of the fingertip,
wherein the information processing device calculates the fingertip movement range on a basis of the angle of the proximal phalanx of each finger of the operator and the movement of the fingertip detected by the motion sensor.

9. The glove according to claim 7, comprising
a fixing tool equipped at each finger of the pair of fingers of the glove to fix the photographing device.

10. The glove according to claim 9,
wherein the fixing tool comprises a ring equipped at each finger of the pair of fingers of the glove, and a rigid body which connects the ring with the photographing device.

11. The glove according to claim 7, wherein the marker has a projecting shape.

12. The glove according to claim 6, wherein the photographing device comprises a plurality of photographing devices.

13. The glove according to claim 6, comprising
a contact force sensor at a position corresponding to an inner side of the fingertip of the operator,
wherein the information processing device acquires information of an excitation force at a contact position of the fingertip for the target object, from the contact force sensor as excitation force information, and acquires displacement of the target object from the target image.
